(19) United States
(12) Patent Application Publication
(10) Pub. No.: US 2016/0314170 A1
(43) Pub. Date: Oct. 27, 2016

(54) SQL Join Plan Representation

(71) Applicant: Dell Software, Inc., Round Rock, TX (US)

(72) Inventors: Wai Yip To, Yaumatei (HK); Ka Wing Luk, Tseung Kwan O (HK)

(73) Assignee: DELL SOFTWARE, INC., Round Rock, TX (US)

(21) Appl. No.: 14/692,169

(22) Filed: Apr. 21, 2015

(51) Int. Cl. G06F 17/30

(52) U.S. Cl. CPC G06F 17/30466

(57) ABSTRACT

A system, method, and computer-readable medium are disclosed for improving the readability and understanding of a SQL query plan by presenting SQL query plan in a join plan representation. In various embodiments, the join plan representation includes one or more of a table join path portion, a statistics portion, an objects axis region and an operator region. The order of the table join path can be easily read in such a representation. Also, statistic figures like cost, IO, CPU and cardinality are all consistently and orderly presented, making it easy for users to understand and compare.

### BACKGROUND OF THE INVENTION

1. Field of the Invention

The present invention relates to information handling systems. More specifically, embodiments of the invention relate to improving the readability and understanding of a SQL query plan by presenting SQL query plan in a join plan representation.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Structured query language (SQL) is a special-purpose programming language designed for managing data held in a relational database management system (RDBMS), or for stream processing in a relational data stream management system (RDSMS). It is known to execute structured query language (SQL) statements on information handling systems to access and interact with a database, the combination of which is generally referred to as a SQL system. A SQL query plan (also referred to as a SQL query execution plan) is an ordered set of steps used to access data in a SQL system.

It is known to represent a SQL query plan as a tree or graph structure diagram with nodes organized in parent-child relationship. One purpose of such a representation is to show the processing methods about how a SQL statement is being executed by the database. A built-in component of a SQL system, called optimizer, is responsible to generate many query plans and select the one with the lowest cost to execute, when given a SQL statement.

However, for many reasons, the final, selected query plan may not be the fastest one for processing a particular input SQL statement. Accordingly, database architects and developers often need to review a query plan representation to understand the information behind the query plan when manually tuning the SQL statements. It is known to represent query plans in trees or graphs. FIG. 1, labeled Prior Art, shows an example of such a tree structure diagram. Plan steps are often embedded into different layers and levels of depth in the tree or graph.

### SUMMARY OF THE INVENTION

A system, method, and computer-readable medium are disclosed for improving the readability and understanding of a SQL query plan by presenting SQL query plan in a join plan representation. In various embodiments, the join plan representation includes one or more of a table join path portion, a statistics portion, an objects axis region and an operator region. The order of the table join path can be easily read in such a representation. Also, statistic figures like cost, JO, CPU and cardinality are all consistently and orderly presented, making it easy for users to understand and compare.

In certain embodiments, the table join path portion which shows a table join path in single direction (e.g., from right to left). Arrows in the table join path portion represent how data are retrieved from the objects and used in the next level. The table join path portion enables SQL query plan users to easily see the data flow in which different tables are joined together. Also, in certain embodiments, the statistics portion allows user to select particular statistics which are associated with an operation in each step in the join plan and then graphically represented (e.g., via charts such as bar charts). The statistics portion enables SQL query plan users to easily see how resources are spent in each step of the query plan. Also, in certain embodiments, the objects axis region shows all referenced objects in the order of their join path. Unlike the nested flow in a tree view or graph, this single-way object axis makes it easy for viewers to understand the join path in a plan. Also in certain embodiments, the operator region shows the operations, data flow, and retrieval methods between objects of the join plan. Different graphical representations (e.g., different arrow styles) are used to represent different data retrieval methods. The operator region allows users to see how data are retrieved and joined in the join plan.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled Prior Art, shows an example of a query plan representation.

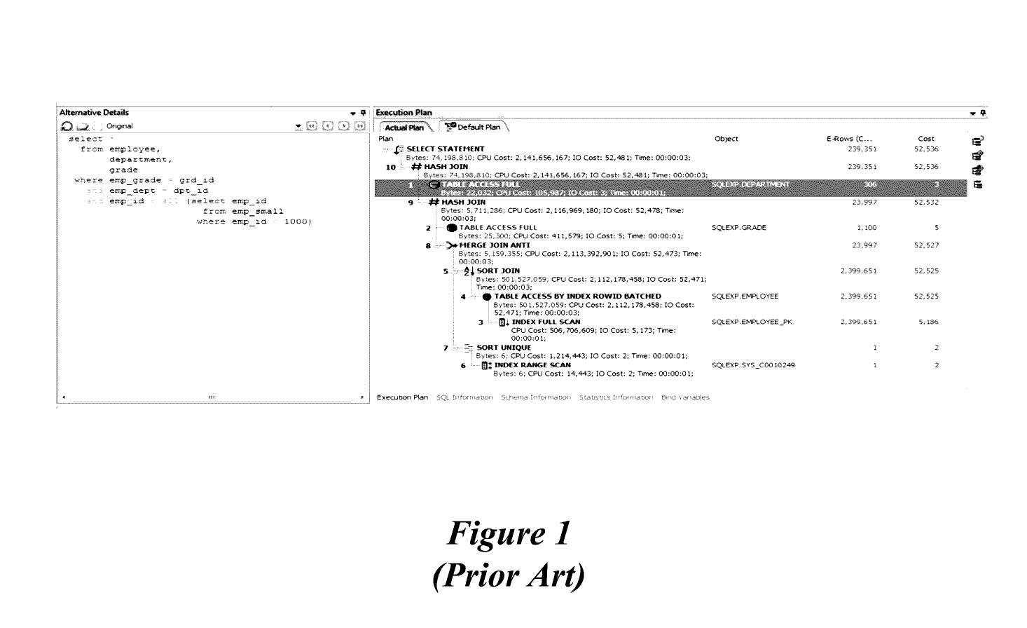

FIG. 2 shows a general illustration of components of an information handling system as implemented in the system and method of the present invention.

FIG. 3 shows a flow chart of the operation of a join plan representation system.

FIG. 4 shows an example of a table join path representation.

FIG. 5 shows an example of a table join path representation accenting a statistics portion.

FIG. 6 shows an example of a table join path representation accenting an objects axis region.

FIG. 7 shows an example of a table join path representation accenting an operator region.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

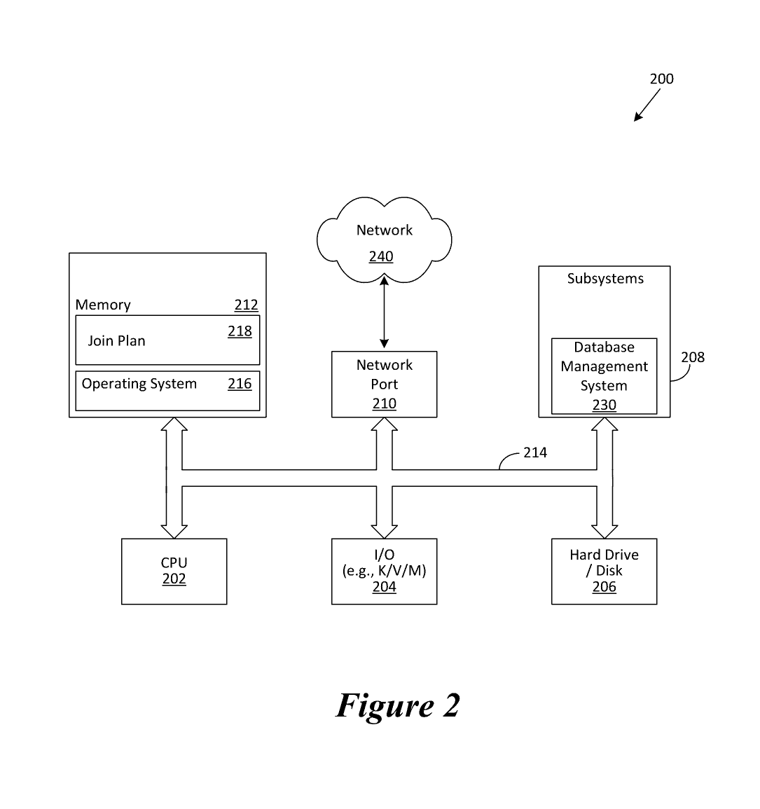

FIG. 2 is a generalized illustration of an information handling system 200 that can be used to implement the system and method of the present invention. The information handling system 200 includes a processor (e.g., central processor unit or “CPU”) 202, input/output (I/O) devices 204, such as a display, a keyboard, a mouse, and associated controllers, a hard drive or disk storage 206, and various other subsystems 208. In various embodiments, the information handling system 200 also includes network port 210 operable to connect to a network 240, which is likewise accessible by a service provider server. The information handling system 200 likewise includes system memory 212, which is interconnected to the foregoing via one or more buses 214. System memory 212 further comprises operating system (OS) 216 and in various embodiments may also comprise join plan representation module 218.

The join plan representation module 218 improves the readability and understanding of a SQL query plan by presenting SQL query plan in a join plan representation. In various embodiments, the join plan representation includes one or more of a table join path portion, a statistics portion, an objects axis region and an operator region. The order of the table join path can be easily read in such a representation. Also, statistic figures like cost, IO, CPU and cardinality are all consistently and orderly presented, making it easy for users to understand and compare.

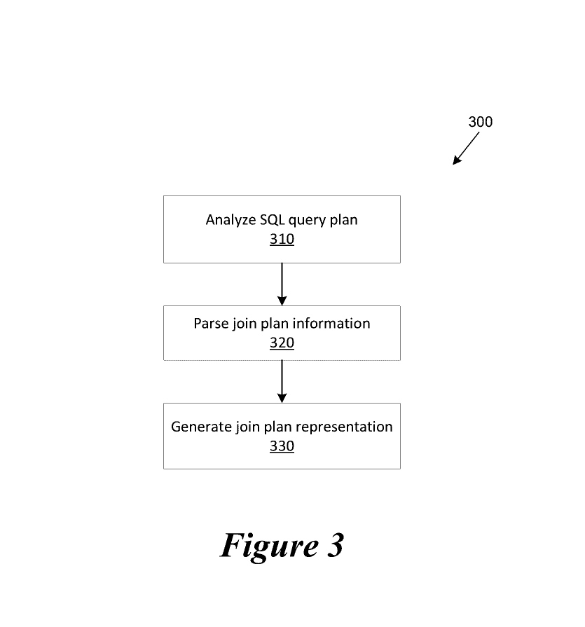

Referring to FIG. 3, a flow chart of the operation of a join plan representation system 300 is shown. In various embodiments, the join plan representation module 218 includes some or all of the operational steps of the join plan representation system 300.

More specifically, operation of the join plan representation system 300 starts at step 310 with the join plan representation system analyzing a SQL query plan. Next, at step 320, the join plan representation system parses the information derived from analyzing the SQL query plan into table join path information, join plan statistics, objects axis information and operator information.

More specifically, the join plan representation system 300 traverses a nested query plan tree and returns database objects in their corresponding order of being accessed (i.e. in the order of join path). The operation steps related to each accessed objects are also tracked and returned. Each object and operation step is then laid on the objects axis region unidirectionally (e.g. from right to left). Information about how objects are joined by different operation steps are used to fill the operator region with arrows showing the flow of data. Various statistic figures are stored in place of each object and operation step so that users can later select which statistic to display in the statistics portion for easy comparison. Next, at step 330, the join plan representation system 300 generates a join plan representation for the analyzed query plan using the table join path information, join plan statistics, objects axis information and operator information.

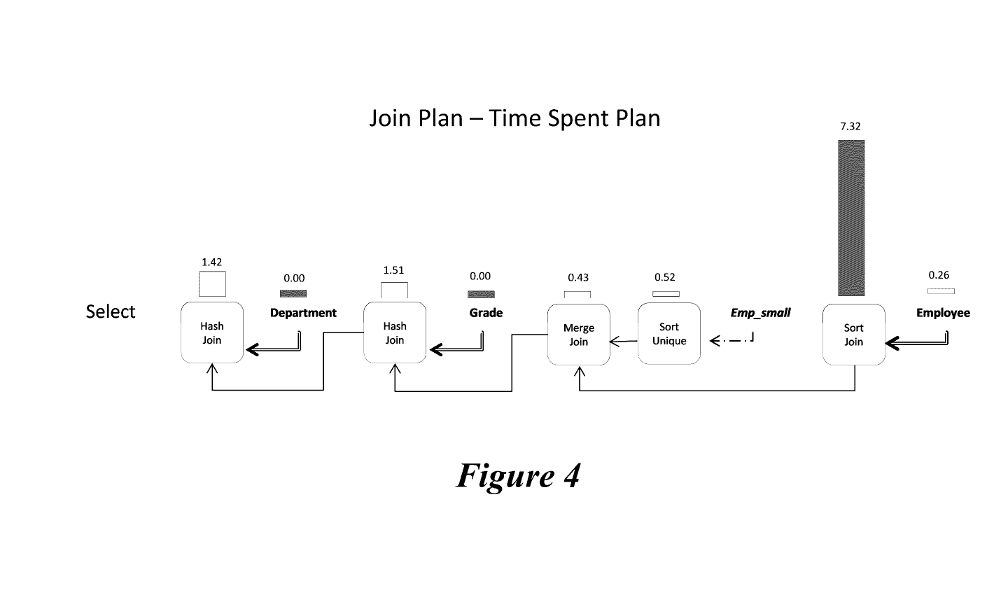

Referring to FIG. 4, an example of a table join path representation is shown. The table join path portion shows a table join path from right to left. Arrows in the table join path portion represent how data are retrieved from the objects and used in the next level. The table join path portion enables SQL query plan users to easily see the data flow in which different tables are joined together.

In certain embodiments, the arrows include unique presentation aspects corresponding to and representing how data are retrieved from the objects and used in the next level. More specifically, in certain embodiments, the unique presentation aspects of the arrows can represent index operations and table access operations.

The index operations include one or more of a unique scan option which represents retrieval of a single row identifier from an index, a range scan option which represents retrieval of one or more row identifiers from an index where indexed values are scanned in ascending order, a range scan descending option which represents retrieval of one or more row identifiers from an index where indexed values are scanned in descending order, a full scan option which represents retrieval of all row identifiers from an index when there is no start or stop key where the indexed values are represented in ascending order, a full scan descending option which represents retrieval of all row identifiers from an index when there is no start or stop key where the indexed values are represented in descending order, a fast full scan option which represents retrieval of all row identifiers and column values using multiple reads, and a skip scan option which represents retrieval of row identifiers from a concatenated index without using a leading column in the index. With the fast full scan option, no sorting order is defined. The fast full scan option compares to a full table scan on only the indexed columns. Additionally, in certain embodiments, the fast full scan option and the skip scan option are only available with a cost based optimizer.

The table access operations include one or more of a full option which represents retrieval of all rows from a table, a sample option which represents retrieval of sampled rows from a table, a cluster option which represents retrieval of rows from a table based on a value of an indexed cluster key, a hash option which represents retrieval of rows from a table based on a hash cluster key value, a by row ID range option which represents retrieval of rows from a table based on a row identifier range, a sample by row ID range option which represents retrieval of sampled rows from a table based on a row identifier range, a by user row ID option which represents retrieval of rows from a table based on user supplied row identifiers, a by index row ID option which represents retrieval of rows from a table based on indexes (for when a table is non partitioned), a by global index row ID option which represents retrieval of rows from a table based on global indexes (for when a table is partitioned), and a by local index row ID option which represents retrieval of rows from a table based on local indexes and possibly some global indexes (for when a table is partitioned). With the by local index row ID option, partition boundaries may be generated by a previous partition step in which case partition start and stop column values replicate the values represent in the partition step and the partition identifier contains the identifier of the partition step. Possible values for the partition start and stop include a number, key or invalid. The partition boundaries may also be generated from a table access or index step itself, in which case the partition identifier contains the identifier of the step. Possible values of the partition start and stop include a number, key or invalid as well as a row remove location (for a table access only).

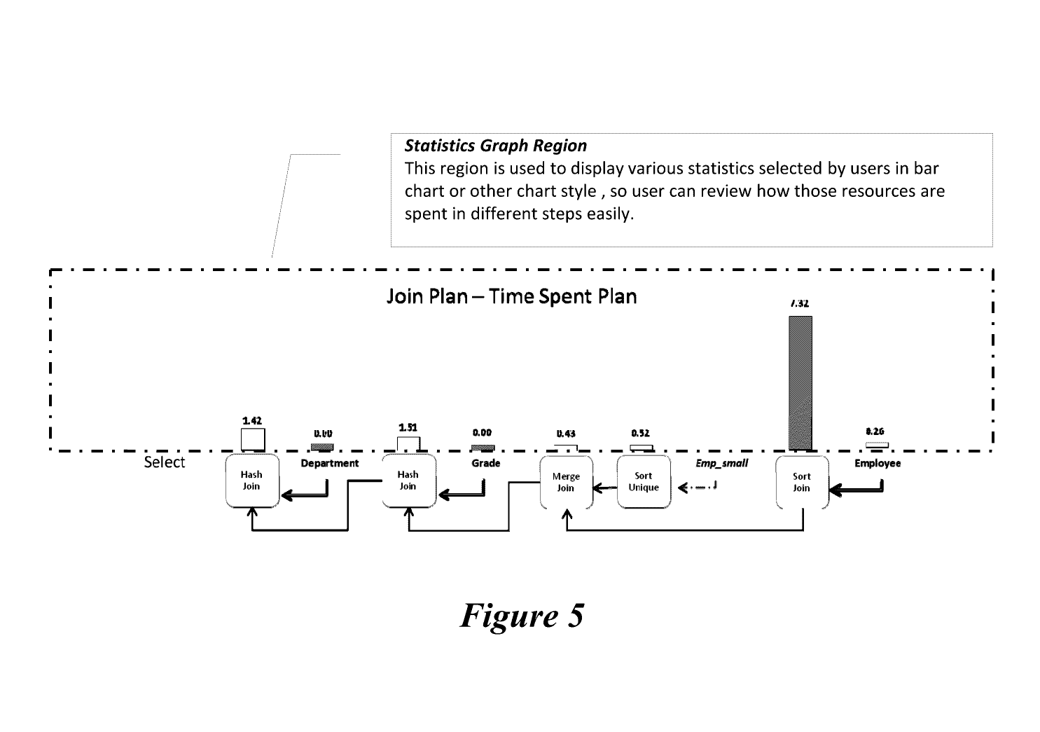

Referring to FIG. 5, an example of a table join path representation accenting a statistics portion is shown. The statistics portion allows user to select particular statistics which are associated with an operation in each step in the join plan and then graphically represented (e.g., via charts such as bar charts). The statistics portion enables SQL query plan users to easily see how resources are spent in each step of the query plan.

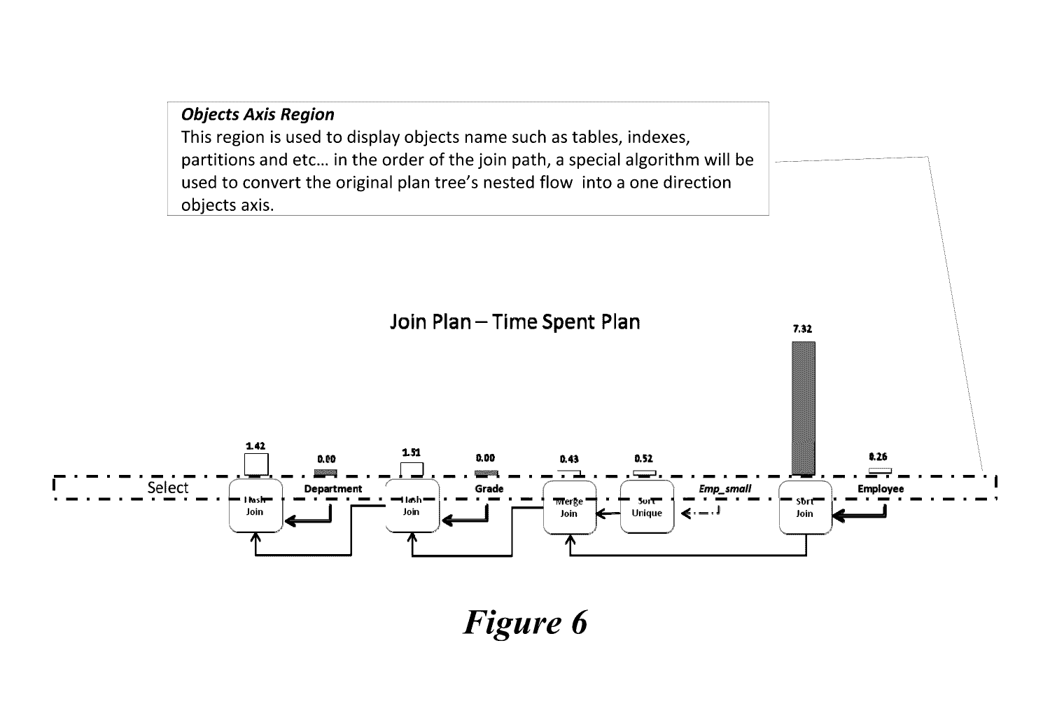

Referring to FIG. 6, an example of a table join path representation accenting an objects axis region is shown. The objects axis region shows all referenced objects in the order of their join path. Unlike the nested flow in a tree view or graph, this single-way object axis makes it easy for viewers to understand how and in what order objects are accessed and joined together in a plan.

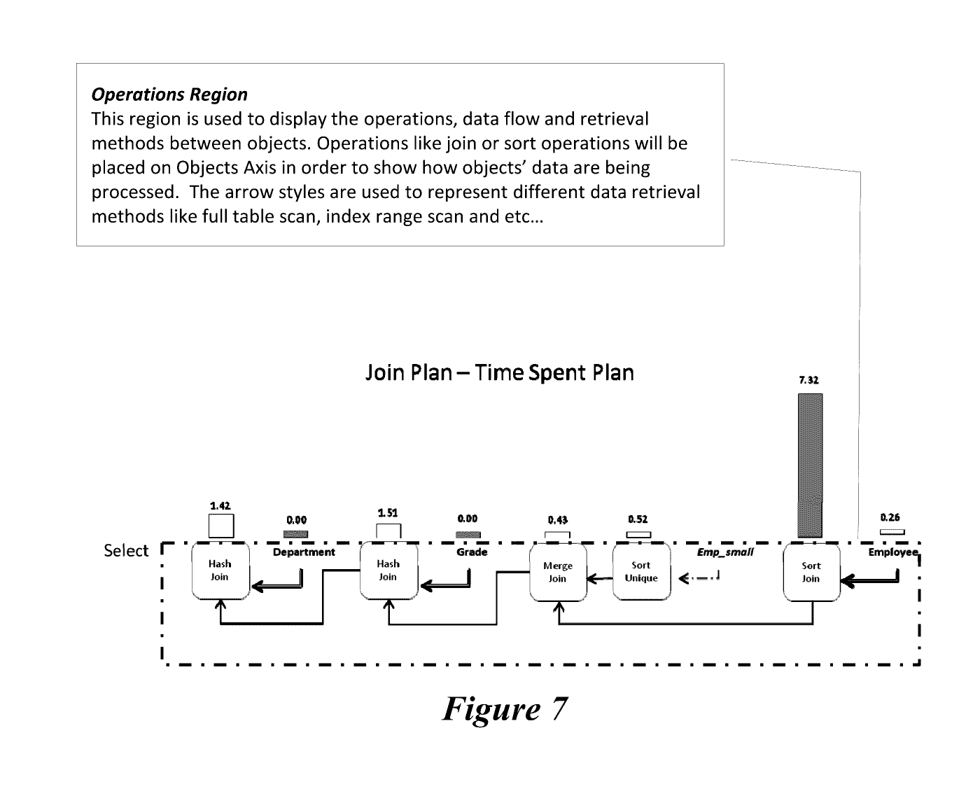

Referring to FIG. 7, an example of a table join path representation accenting an operator region is shown. The operator region shows the operations, data flow, and retrieval methods between objects of the join plan. Different graphical representations (e.g., different arrow styles) are used to represent different data retrieval methods. The operator region allows users to see how data are retrieved and joined in the join plan.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

What is claimed is:

1. A computer-implementable method for presenting a structured query language (SQL) query plan, comprising:
analyzing a SQL query plan to generate SQL join plan information;
parsing the SQL join plan information derived from analyzing the SQL query plan into a plurality of types of SQL join plan information; and,
generating a join plan representation for the analyzed query plan using the plurality of types of SQL join plan information.

2. The method of claim 1, wherein:
the plurality of types of SQL join plan information comprises at least one of table join path information, join plan statistics, objects axis information and operator information; and,
the generating a join plan representation comprises at least one of generating a table join path portion, a statistics portion, an objects axis region and an operator region.

3. The method of claim 2, wherein:
the table join path portion shows a table join path in a single direction; and,
arrows in the table join path portion represent how data are retrieved from SQL objects and are used in a next level of the join plan.

4. The method of claim 2, wherein:
the statistics portion allows user to select particular statistics associated with an operation in each step in the join plan.

5. The method of claim 2, wherein:
the objects axis region shows all referenced objects in an order of their join path.

6. The method of claim 2, wherein:
the operator region shows operations, data flow, and retrieval methods between objects of the join plan.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
analyzing a SQL query plan to generate SQL join plan information;
parsing the SQL join plan information derived from analyzing the SQL query plan into a plurality of types of SQL join plan information; and,
generating a join plan representation for the analyzed query plan using the plurality of types of SQL join plan information.

8. The system of claim 7, wherein:
the plurality of types of SQL join plan information comprises at least one of table join path information, join plan statistics, objects axis information and operator information; and,
the generating a join plan representation comprises at least one of generating a table join path portion, a statistics portion, an objects axis region and an operator region.

9. The system of claim 8, wherein:
the table join path portion shows a table join path in a single direction; and,
arrows in the table join path portion represent how data are retrieved from SQL objects and are used in a next level of the join plan.

10. The system of claim 8, wherein:
the statistics portion allows user to select particular statistics associated with an operation in each step in the join plan.

11. The system of claim 8, wherein:
the objects axis region shows all referenced objects in an order of their join path.

12. The system of claim 8, wherein:
the operator region shows operations, data flow, and retrieval methods between objects of the join plan.

13. A non-transitory, computer-readable storage medium embodying computer program code, the computer program code comprising computer executable instructions configured for:
analyzing a SQL query plan to generate SQL join plan information;
parsing the SQL join plan information derived from analyzing the SQL query plan into a plurality of types of SQL join plan information; and,
generating a join plan representation for the analyzed query plan using the plurality of types of SQL join plan information.

14. The non-transitory, computer-readable storage medium of claim 13, wherein:
the plurality of types of SQL join plan information comprises at least one of table join path information, join plan statistics, objects axis information and operator information; and,
the generating a join plan representation comprises at least one of generating a table join path portion, a statistics portion, an objects axis region and an operator region.

15. The non-transitory, computer-readable storage medium of claim 14, wherein:
the table join path portion shows a table join path in a single direction; and,
arrows in the table join path portion represent how data are retrieved from SQL objects and are used in a next level of the join plan.

16. The non-transitory, computer-readable storage medium of claim 14, wherein:
the statistics portion allows user to select particular statistics associated with an operation in each step in the join plan.

17. The non-transitory, computer-readable storage medium of claim 14, wherein:
the objects axis region shows all referenced objects in an order of their join path.

18. The non-transitory, computer-readable storage medium of claim 14, wherein:
the operator region shows operations, data flow, and retrieval methods between
